(19) United States
(12) Patent Application Publication
(10) Pub. No.: US 2010/0275255 A1
(43) Pub. Date: Oct. 28, 2010

(54) PERSON CENTRIC SYSTEM AND METHOD TRANSFORMING HEALTH DATA TO HEALTH RISKS DATA

(76) Inventors: Lisa Feldman, Chicago, IL (US); Paul Witherspoon, Framingham, MA (US)

Correspondence Address: Hallihan IP Partners, LLC, 117 N. Jefferson Street, Suite 200, Chicago, IL, 60661, US

(21) Appl. No.: 12/764,257

(22) Filed: Apr. 21, 2010

Related U.S. Application Data
(60) Provisional application No. 61/173,297, filed on Apr. 28, 2009.

(51) Int. Cl. G06F 21/00

(52) U.S. Cl. 726/17

(57) ABSTRACT

Constrained by a permissions wall and a security wall, the method and the system execute a risk transformation which transforms lay users health data sets to lay users risks data sets, outputs lay users risks data set, can output lay users best practice data sets corresponding to lay users risks data sets, can output lay users educational data sets corresponding to lay users risks data sets, and can output for research users research compilations from lay users health data sets and from lay users risks data sets.

This application claims priority of U.S. provisional application 61/173,297 (confirmation number 4589) filed 28 Apr. 2009 which is incorporated herein by reference.

Lay users permissions constrain operation of the method and system thereby providing unexpected enhanced transparency of clinical interactions between lay users and clinical users and enhanced encouragement of best practices by clinical users.

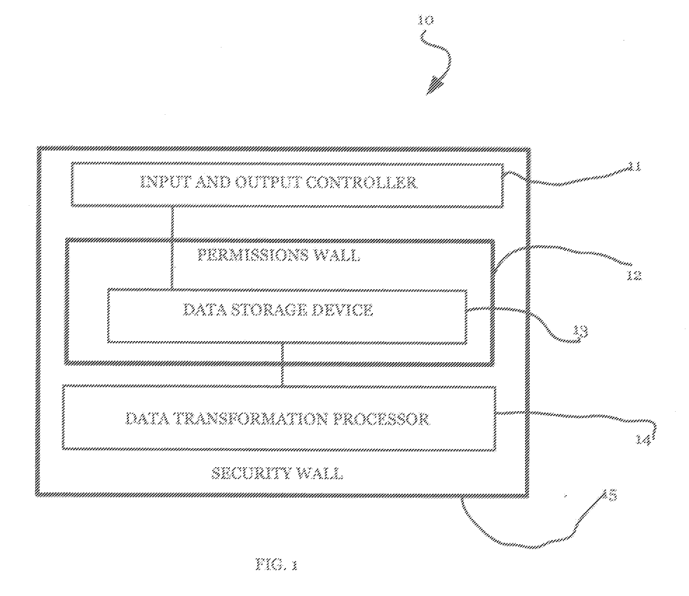

FIG. 1 schematically shows elements—input and output controller 11, permissions wall 12, data storage device 13, data transformation processor 14, and security wall 15—of the system 10.

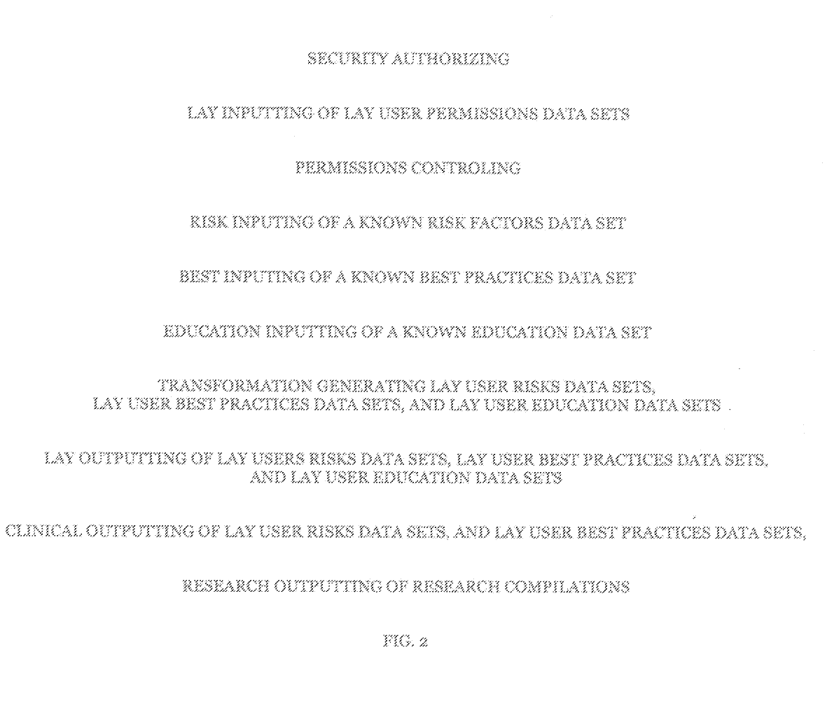

FIG. 2 shows key steps in the method which the system operates.

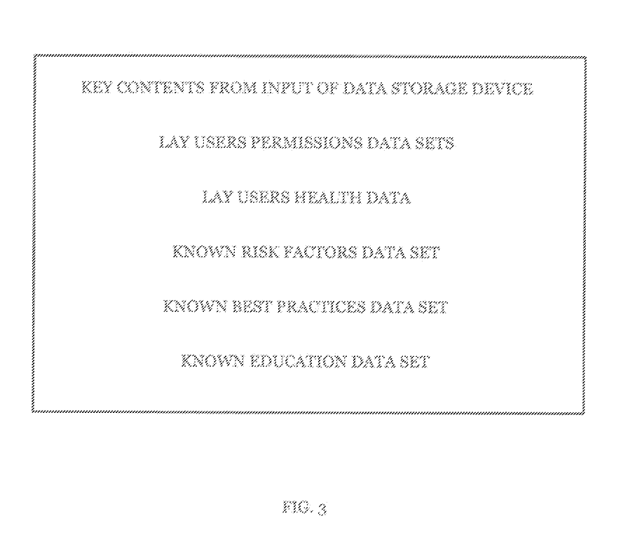

FIG. 3 shows key contents from input of the data storage device of FIG. 1.

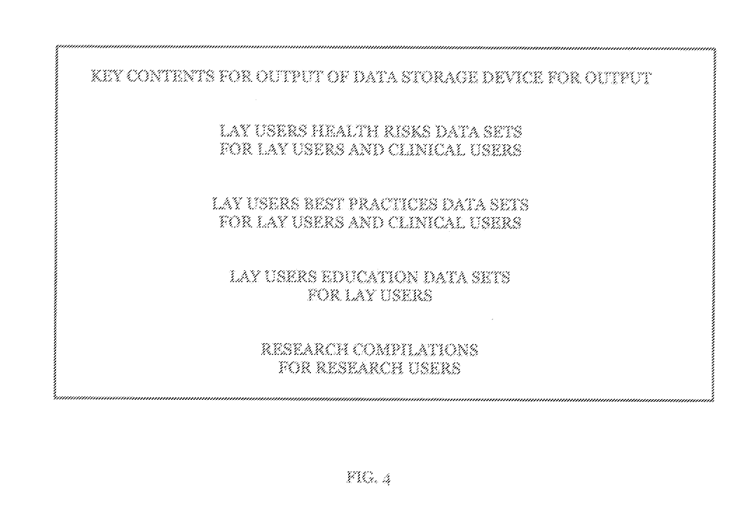

FIG. 4 shows key contents for output of the data storage device of FIG. 1.

The input and output controller, the data storage device, and the data transformation processor are together surrounded by a security wall and the data storage device is surrounded by a permissions wall.

There is security authorizing at the security wall between the input and output controller and external input sources and external output sources so that no datum from an input source is input via the input and output controller unless the input source is security authorized to input data and no datum is output via the input and output controller for an output source unless the output source is security authorized to receive output data.

In the strong form of the permissions wall no lay users health datum in the lay users health data sets passes into, nor out of, the data storage device unless permitted by the lay users permissions data sets.

As constrained by lay users permissions data sets, the method and the system execute a risk transformation which transforms lay users health data sets to lay users risks data sets, outputs lay users risks data set, can output lay users best practice data sets corresponding to lay users risks data sets, and can output lay users educational data sets corresponding to lay users risks data sets.

The method and system can output for research users research compilations from lay users health data sets and from lay users risks data sets.

The risks transformation uses a known risks factors data set, a known best practices data set, and a known education data set.

The person centric health data transformation method comprises lay inputting via an input and output controller to a data storage device of lay user data sets. The lay users data sets comprise lay users permissions data sets and lay users health data sets.

The lay inputting step includes a lay revising step which updates the lay users data sets as lay users permissions data change and as lay users health data change. The data storage device is operatively connected with the input and output controller and with a data transformation processor.

The method also comprises risk inputting via the input and output controller to the data storage device of a known risk factor data set. The risk inputting step includes a risk revising step which updates the known risk factor data set as knowledge of risk factors changes.

The method can also comprise best inputting via the input and output controller to the data storage device of a known best practices data set. The best inputting step includes a best revising step which updates the known best practices data set as knowledge of best practices changes.

The method can also comprise education inputting via the input and output controller to the data storage device of a known education data set. The education inputting step includes an education revising step which updates the known education data set as knowledge of education changes.

The method also comprises transforming by the data transformation processor which executes a risk transformation which compares the lay users health data sets and the known health risks data set to generate lay users risks data sets.

The transforming step can also generate lay users best practices data sets. Lay users best practices data sets correspond to lay users risks data sets. The transforming step can also generate lay users education data sets. Lay users education data sets correspond to lay users risks data sets.

The method also comprises lay outputting of lay users risks data set for lay users as allowed by lay users permissions data sets. Lay outputting can also comprise lay best outputting of lay users best practices data sets for the lay users as allowed by lay users permissions data sets. Lay outputting can also comprise lay education outputting of lay users education data sets for lay users as allowed by lay users permissions data sets. Lay outputting can also comprise relative outputting of these several data sets for lay users' genetic relatives as allowed by lay users permissions data sets

The method also comprises clinical outputting of lay users risks data sets for clinical users as allowed by the lay users permissions data sets. Clinical outputting can also comprise lay best outputting of lay users best practices data sets for clinical users as allowed by lay users permissions data sets.

The method can also comprise research outputting for research users of research compilations from lay users health data sets and from lay users health risk data sets for research users as allowed by lay users data sets.

Users of the system comprise lay users, administrative users, clinical users, and research users. Lay users are persons using the system to learn about their health risks and to learn how to reduce their health risks. Administrative users are persons operating the system. Clinical users are persons and entities offering health services to lay users. Research users are persons and research entities using the system to obtain data for research and to input relevant research results. Each of these several users must have security clearance in order for data to pass through the security wall into and out of the data storage device.

Lay users data sets can be input by lay users themselves and by authorized agents of lay users. Administrative users can be these authorized agents. Each lay user has a lay user data set included in the lay users data sets. Lay users data sets comprise lay users permissions data sets and lay users health data sets.

Lay users permissions data sets are the base for the permissions wall. In the strong form of the permissions wall no datum from a lay user data set passes through the permissions wall into, nor out of, the data storage device unless allowed by that lay user permissions data set. Revisions of lay users permissions data sets from corresponding lay users can update the lay users permissions data sets.

A lay users health data set comprises any health data which can contribute to health risks for that lay user. This health data can comprise genetic data, epigenetic data, environmental data, family data, and historical data. The lay user health data set can be updated by revisions from the lay user as new data comes available and as knowledge of health risks factors changes. Parts of the lay user data set can be input directly from an entity generating that data. For example, a DNA sequencing entity can input genetic data directly, if security authorized; and if, in the strong form of the permissions wall, permitted by the lay user permissions data set.

The known risks data set comprises all factors known to contribute to health risks, factors for example comprising genetic factors, epigenetic factors, environmental factors, historical factors, and family history factors. Combinations within factor categories and among factor categories are also included. Since this information is widely distributed among researchers and research entities administrative users can compile and continually revise the known risks data set as knowledge changes. Contributions to the known risks data set can come directly from researchers and research entities.

The known best practices data set comprises best practices for treatment of, and for reduction of, health risks. “Health risk” is used herein to comprise the full spectrum from risk of a condition occurring through mild occurrences to acute occurrences and beyond. Since this information is widely distributed among researchers and research entities administrative users can compile and continually revise the best practices data set as knowledge changes. Contributions to the best practices risks data set can come directly from researchers and research entities.

Since best practices data can be expressed in specialist language, the known education data set provides help for understanding the specialist language and for applying best practice recommendations. Since this information is widely distributed among various entities, administrative users can compile and continually revise the known education data set as knowledge changes. Contributions to the known education risks data set can come directly from various entities.

The method for transforming health data to health risks data is operated by a system comprising an input and output controller, a data storage device, and a transformation processor. The input and output controller, the data storage device, and the data transformation processor are together surrounded by a security wall and the data storage device is surrounded by a permissions wall.

There is security authorizing at the security wall between the input and output controller and external input sources and external output sources so that no datum from an input source is input via the input and output controller unless the input source is security authorized to input data and no datum is output via the input and output controller for an output source unless the output source is security authorized to receive output data.

The input and output controller can prompt for input of lay users data sets, of known risks data sets, of known best practices data sets, and of known education data sets. Input to the data storage device occurs only if the source of the input is security authorized to pass the security wall; and, in the strongest form of the permissions wall, only if a corresponding lay user permissions data set allows.

The data transformation processor can compare a lay user health data set in the data storage device with the known health risks data set to generate a lay user risks data set, generate a corresponding lay user best practices data set, and generate a corresponding lay user education data set.

The data transformation processor can use lay users health data sets and lay user risks data sets to generate research compilations which can be specified by research users.

Output of lay user risks data sets, lay user best practices data sets, lay user education data sets, and research compilations occurs via the input and output controller only if allowed by corresponding lay user permissions data sets for passage through the permissions wall and only as authorized for passage through the security wall.

1. A person centric health data transformation method comprising:
lay inputting via an input and output controller to a data storage device of lay user data sets,
where the lay users data sets comprise lay users permissions data sets and lay users health data sets,
where the lay inputting step includes a lay revising step which updates the lay users data sets as lay users permissions data change and as lay users health data change,
where the data storage device is operatively connected with the input and output controller and with a data transformation processor
where the input and output controller, the data storage device, and the data transformation processor are together surrounded by a security wall and the data storage device is surrounded by a permissions wall;
security authorizing at the security wall between the input and output controller and external input sources and external output sources so that no datum from an input source is input via the input and output controller unless the input source is security authorized to input data and so that no datum is output via the input and output controller for an output source unless the output source is security authorized to receive output data;
risk inputting via the input and output controller to the data storage device of a known risk factor data set,
where the risk inputting step includes a risk revising step which updates the known risk factor data set as knowledge of risk factors changes;
transforming by the data transformation processor which executes a risk transformation which compares the lay users health data sets and the known health risks data set to generate lay users risks data sets,
lay outputting of lay users risks data set for lay users as allowed by lay users permissions data sets,
clinical outputting of lay users risks data sets for clinical users as allowed by the lay users permissions data sets.

2. The method of claim 1 further comprising permissions controlling of the data storage device so that no lay users health datum in the lay users health data sets passes into, nor out of, the data storage device unless permitted by the lay users permissions data sets.

3. The method of claim 1 further comprising:
best inputting via the input and output controller to the data storage device of a known best practices data set,
where the best inputting step includes a best revising step which updates the known best practices data set as knowledge of best practices changes;
where the transforming step has a best transforming component step which generates lay users best practices data sets,
where lay users best practices data sets correspond to lay users risks data sets,
where lay outputting has a lay best outputting component step which outputs lay users best practices data sets for the lay users as allowed by lay users permissions data sets, and
where clinical outputting has a clinical best outputting component step which outputs lay users best practices data sets for clinical users as allowed by lay users permissions data sets.

4. The method of claim 3 further comprising:
education inputting via the input and output controller to the data storage device of a known education data set,
where the education inputting step includes an education revising step which updates the known education data set as knowledge of education changes;
where the transforming step has an education transforming component step which generates lay users education data sets,
where lay users education data sets correspond to lay users risks data sets; and
where lay outputting has a lay education outputting component step which outputs lay users education data sets for lay users as allowed by lay users permissions data sets.

5. The method of claim 1 further comprising:
research outputting for research users of research compilations from lay users health data sets and from lay users risk data sets for research users.

6. The method of claim 2 further comprising:
best inputting via the input and output controller to the data storage device of a known best practices data set,
where the best inputting step includes a best revising step which updates the known best practices data set. as knowledge of best practices changes;
where the transforming step has a best transforming component step which generates lay users best practices data sets,
where lay users best practices data sets correspond to lay users risks data sets,
where lay outputting has a lay best outputting component step which outputs lay users best practices data sets for the lay users as allowed by lay users permissions data sets, and
where clinical outputting has a clinical best outputting component step which outputs lay users best practices data sets for clinical users as allowed by lay users permissions data sets.

7. The method of claim 6 further comprising:
education inputting via the input, and output controller to the data storage device of a known education data set,
where the education inputting step includes an education revising step which updates the known education data set as knowledge of education changes;
where the transforming step has an education transforming component step which generates lay users education data sets,
where lay users education data sets correspond to lay users risks data sets; and
where lay outputting has a lay education component step which outputs lay users education data sets for lay users as allowed by lay users permissions data set.

8. The method of claim 2 further comprising:
research outputting for research users of research compilations from lay users health data sets and from lay users risk data sets for research users.

9. A person centric health data transformation method comprising:
lay inputting via an input and output controller to a data storage device of lay user data sets,
where the lay users data sets comprise lay users permissions data sets and lay users health data sets,
where the lay inputting step includes a lay revising step which updates the lay users data sets as lay users permissions data change and as lay users health data change,
where the data storage device is operatively connected with the input and output controller and with a data transformation processor,
where the input and output controller, the data storage device, and the data transformation processor are together surrounded by a security wall and the data storage device is surrounded by a permissions wall;
security authorizing at the security wall between the input and output controller and external input sources and external output sources so that no datum from an input source is input via the input and output controller unless the input source is security authorized to input data and no datum is output via the input and output controller for an output source unless the output source is security authorized to receive output data;
risk inputting via the input and output controller to the data storage device of a known risk factor data set,
where the risk inputting step includes a risk revising step which updates the known risk factor data set as knowledge of risk factors changes;
best inputting via the input and output controller to the data storage device of a known best practices data set,
where the best inputting step includes a best revising step which updates the known best practices data set as knowledge of best practices changes;
education inputting via the input and output controller to the data storage device of a known education data set,
where the education inputting step includes an education revising step which updates the known education data set as knowledge of education changes;
transforming by the data transformation processor which executes a risk transformation which compares the lay users health data sets and the known health risks data set to generate lay users health risks datasets,
where the transforming step also generates lay users best practices data sets,
where lay users best practices data sets correspond to lay users risks data sets,
where the transforming step also generates lay users education data sets,
where lay users education data sets correspond to lay users risks data sets;
lay outputting comprising outputting of lay users risks data set for lay users as allowed by lay users permissions data sets,
where lay outputting also comprises outputting of lay users best practices data sets for the lay users as allowed by lay users permissions data sets,
where lay outputting also comprises outputting of lay users education data sets for lay users as allowed by lay users permissions data sets,
clinical outputting lay users risks data sets for clinical users as allowed by the lay users permissions data sets,
where clinical outputting also comprises outputting of lay users best practices data sets for clinical users as allowed by lay users permissions data sets; and
research outputting for research users of research compilations from lay users health data sets and from lay users risk data sets for research users.

10. The method of claim 9 further comprising permissions controlling of the data storage device so that no lay users health datum in the lay users health data sets passes into, nor out of, the data storage device unless permitted by the lay users permissions data sets.

11. A person centric health data transformation system comprising:
an input and output controller operatively connected with a data storage device operatively connected with a data transformation processor;
a security wall between the input and output controller and external input sources and external output sources so that no datum from an input source is input via the input and output controller unless the input source is security authorized to input data and no datum is output via the input and output controller for an output source unless the output source is security authorized to receive output data;
a permissions wall around the data storage device,
where lay inputting inputs lay user data sets via the input and output controller to the data storage device,
where the lay users data sets comprise lay users permissions data sets and lay users health data sets,
where lay inputting step includes lay revising which updates the lay users data sets as lay users permissions data change and as lay users health data change,
where risk inputting from administrative users inputs a known risk factors data set via the input and output controller to the data storage device,
where risk inputting includes risk revising which updates the known risk factor data set as knowledge of risk factors changes;
where best inputting inputs from administrative users a known best practices data set via the input and output controller to the data storage device,
where best inputting includes best revising which updates the known best practices data set as knowledge of best practices changes;
where education inputting inputs from administrative users a known education data set via the input and output controller to the data storage device,
where education inputting includes education revising which updates the known education data set as knowledge of education changes;
where transforming by the data transformation processor executes a risk transformation which compares the lay users health data sets and the known health risks data set to generate lay users health risks data sets,
where the risk transformation also generates lay users best practices data sets,
where lay users best practices data sets correspond to lay users risks data sets,
where the risk transformation also generates lay users education data sets,
where lay users education data sets correspond to lay users risks data sets;
where lay outputting outputs lay users risks data sets for lay users as allowed by lay users permissions data sets,
where lay outputting also output lay users best practices data sets for the lay users as allowed by lay users permissions data sets,
where lay outputting also outputs lay users education data sets for lay users as allowed by lay users permissions data sets,
where clinical outputting outputs lay users risks data sets for lay clinical users as allowed by the lay users permissions data sets,
where clinical outputting also outputs lay users best practices data sets for clinical users as allowed by lay users permissions data sets,
where research outputting outputs research compilations for research users, and
where the research compilations are from lay users health data sets and from lay users health risk data sets for research users.

12. The method of claim 11 further comprising permissions controlling of the data storage device so that no lay users health datum in the lay users health data sets passes into, nor out of, the data storage device unless permitted by the lay users permissions data sets.
